(19) United States
(12) Patent Application Publication
(10) Pub. No.: US 2006/0117266 A1
(43) Pub. Date: Jun. 1, 2006

(54) Information processing device, method for indicating items, and computer program product for indicating items

(75) Inventors: Mitsuhiko Yamamoto, Kawasaki (JP); Satoru Sugita, Shinagawa (JP); Takashi Arita, Shinagawa (JP); Satoshi Sakurai, Shinagawa (JP)

Correspondence Address: STAAS & HALSEY LLP, SUITE 700, 1201 NEW YORK AVENUE, N.W., WASHINGTON, DC, 20005, US

(73) Assignees: FUJITSU COMPONENT LIMITED, Tokyo (JP); FUJITSU LIMITED, Kawasaki (JP)

(21) Appl. No.: 11/137,423

(22) Filed: May 26, 2005

(30) Foreign Application Priority Data
Dec. 1, 2004 (JP) 2004-348419

(51) Int. Cl. G06F 9/00

(52) U.S. Cl. 715/764

(57) ABSTRACT

An information processing device, includes an indicating part capable for indicating plural items on an indication picture, an indication switch configured to switch the number of the items indicated on the indication picture of the indicating part, and an items indication control part configured to switch the number of items indicated on the indication picture corresponding to the operation of the indication switch.

### BACKGROUND OF THE INVENTION

1. Field of the Invention

The present invention generally relates to information processing devices, methods for indicating items, and computer program products for indicating items, and more specifically, to an information processing device, a method for indicating items, and a computer program product for indicating items, whereby a menu formed by plural items is indicated at an indication part.

2. Description of the Related Art

Recently, a small-sized information processing device such as a portable phone has a multifunctional tendency and therefore the number of settable and selectable items in the information processing device is increasing. On the other hand, the information processing device is required to be made small-sized. If the device is made small-sized, an indication picture is also small-sized so that the amount of information that can be indicated on the indication picture at one time is reduced. Because of this, the related small-sized information device corresponds to multi-items by making an operations menu multi-hierarchical.

On the other hand, since the information device such as the portable phone is small-sized, there is a limitation in the number of the input keys and therefore the operability of the information device is bad. Because of this, a portable phone wherein at least one of the input keys is configured as a two-step depression switch capable of 2-step depressing operations is suggested. See Japan-Laid Open Patent Application Publication No. 2003-87371.

However, in a case where the operations menu is made multi-hierarchical, items are selected in turn from an upper hierarchy so that a necessary item is obtained. Therefore, the necessary item cannot be directly found and therefore it is difficult to select the necessary item. Hence, there is a problem in that the operability of the information device is bad.

### SUMMARY OF THE INVENTION

Accordingly, it is a general object of the present invention to provide a novel and useful information processing device, method for indicating items, and computer program product for indicating the items.

Another and more specific object of the present invention is to provide an information processing device, a method for indicating items, and a computer program product for indicating items whereby an operation for selecting the items can be easily performed.

The above object of the present invention is achieved by an information processing device, including:

an indicating part capable for indicating plural items on an indication picture;

an indication switch configured to switch the number of the items indicated on the indication picture of the indicating part; and

an items indication control part configured to switch the number of items indicated on the indication picture corresponding to the operation of the indication switch.

The above object of the present invention is achieved by a method for indicating items, including:

a step of switching the number of items indicated on an indication picture of an indicating part, corresponding to the operation of an indication switch.

The above object of the present invention is achieved by a computer program product for indicating items, the product having a computer readable program, the program including:

a step of switching the number of items indicated on an indication picture of an indicating part, corresponding to the operation of an indication switch.

According to the above-mentioned invention, it is possible to easily select items by switching the number of the items indicated on the picture corresponding to the operation of the indication switch, so that the operability can be improved. In addition, since all of the items can be managed as a single menu, it is possible to easily manage the items.

Other objects, features, and advantages of the present invention will be come more apparent from the following detailed description when read in conjunction with the accompanying drawings.

### BRIEF DESCRIPTION OF THE DRAWINGS

FIG. 1 is a block diagram of an embodiment of the present invention;

FIG. 2 is a plan view of the embodiment of the present invention;

FIG. 3 is a flowchart of an item indicating process of a process device 12;

FIG. 4 is a schematic view of an indication picture;

FIG. 5 is a schematic view of another indication picture;

FIG. 6 is a schematic view of an indication picture of a modified example of the second indication picture;

FIG. 7 is a schematic view of an indication picture where received mail is indicated;

FIG. 8 is a flowchart of a first modified example of the item indicating process;

FIG. 9 is a flowchart of a second modified example of the item indicating process;

FIG. 10 is a flowchart of a third modified example of the item indicating process;

FIG. 11 is a schematic view for explaining a two-step depression switch;

FIG. 12 is a flowchart of a fourth modified example of the item indicating process;

FIG. 13 is a flowchart of a fifth modified example of the item indicating process;

FIG. 14 is a flowchart of a sixth modified example of the item indicating process;

FIG. 15 is a flowchart of a seventh modified example of the item indicating process;

FIG. 16 is a flowchart of an eighth modified example of the item indicating process;

FIG. 17 is a flowchart of a ninth modified example of the item indicating process;

FIG. 18 is a schematic view for explaining a three-step depression switch;

FIG. 19 is a flowchart of a tenth modified example of the item indicating process; and

FIG. 20 is a schematic view of the indication picture for explaining a large classification picture indication.

### DETAILED DESCRIPTION OF THE PREFERED EMBODIMENTS

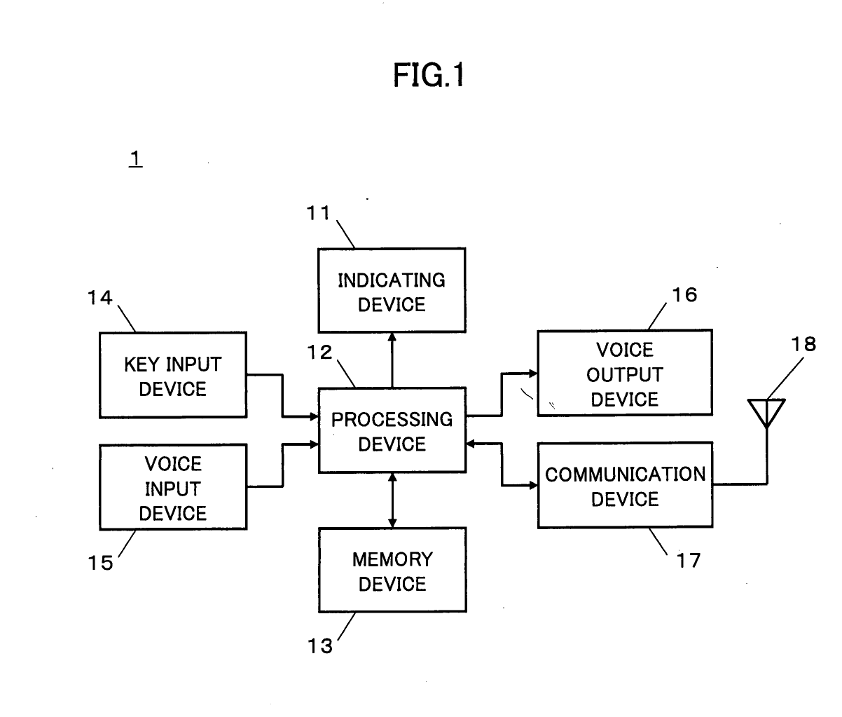

A description is given below, with reference to the FIG. 1 through FIG. 20 of embodiments of the present invention.

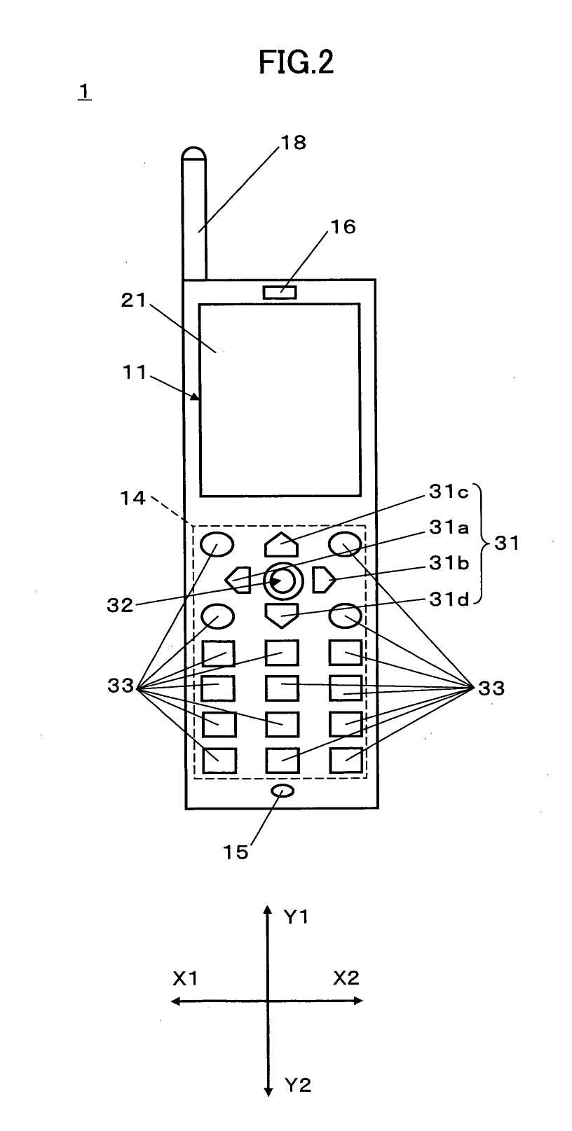

FIG. 1 is a block diagram of an embodiment of the present invention. FIG. 2 is a plan view of the embodiment of the present invention.

An information processing device 1 of this embodiment is, for example, a small-sized information device such as a portable phone. The information processing device 1 includes an indication device 11, a processing device 12, a memory device 13, a key input device 14, a voice input device 15, a voice output device 16, a communication device 17, and an antenna 18.

The indication device 11 is, for example, formed by a flat display such as a liquid crystal display. The indication device 11 indicates an image corresponding to indication data supplied from the processing device 12 on an indication picture 21.

The processing device 12 performs data processing based on a program stored in the memory device. The processing device 12 performs data processing based on an instruction supplied from the key input device 14. The processing device 12 forms the indication data and supplies them to the indication device 11. The memory device 13 is formed by a nonvolatile memory device and the program or data are stored in the memory device 13.

The key input device 14 includes coordinates input keys 31, a zoom switch key 32, character input keys 33, or the like. The coordinates input keys 31 includes an X1 direction coordinates moving key 31a, an X2 direction coordinates moving key 31b, a Y1 direction coordinates moving key 31c, and a Y2 direction coordinates moving key 31d.

The X1 direction coordinates moving key 31a is a switch for moving a cursor or pointer in the X1 direction or moving a selected item in the X1 direction. The X2 direction coordinates moving key 31b is a switch for moving a cursor or pointer in the X2 direction or moving a selected item in the X2 direction. The Y1 direction coordinates moving key 31c is a switch for moving a cursor or pointer in the Y1 direction or moving a selected item in the Y1 direction. The Y2 direction coordinates moving key 31d is a switch for moving a cursor or pointer in the Y2 direction or moving a selected item in the Y2 direction.

In a case where the zoom switch 32 is turned off, items of 3 columns×3 rows, for example, of items arranged as n columns×m rows are displayed on the indication device 11. In a case where the zoom switch 32 is turned on, all of the items arranged as n columns×m rows, for example, are displayed on the indication device 11.

The voice input device 15 is formed by a microphone or the like and is used for inputting voice at the time of a telephone call. The voice output device 16 is formed by a speaker, a buzzer, or the like and is used for outputting the voice, sound indicating receiving the phone call, effective sound, or the like, at the time of a telephone call. The communication device 17 implements modulation and demodulation processes for sending and receiving data. The antenna 18 is used for sending and receiving a radio wave.

Next, an item indicating process by the process device 12 is discussed.

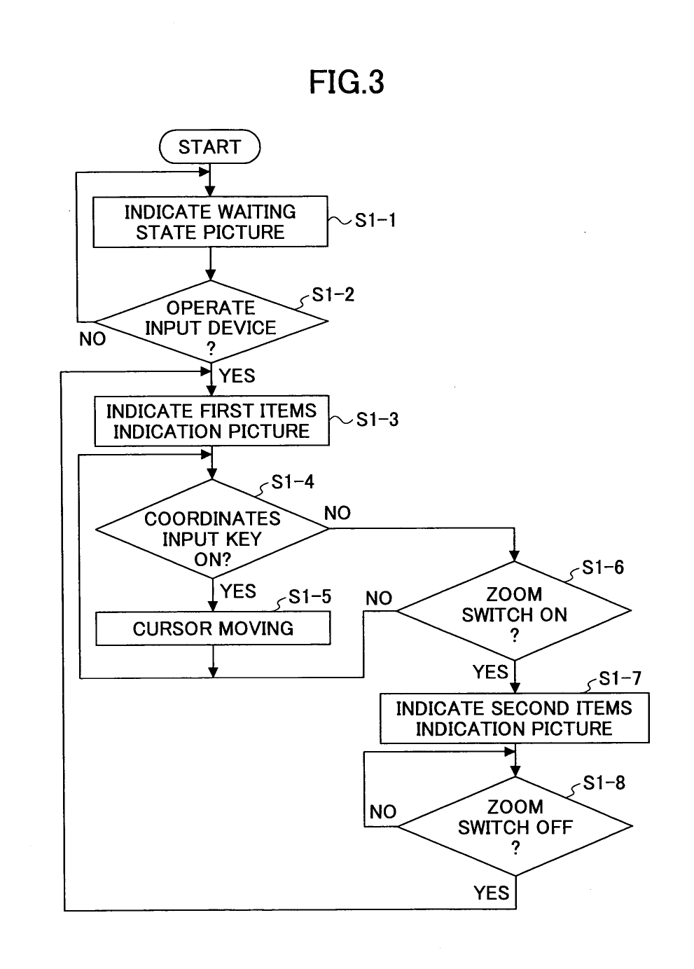

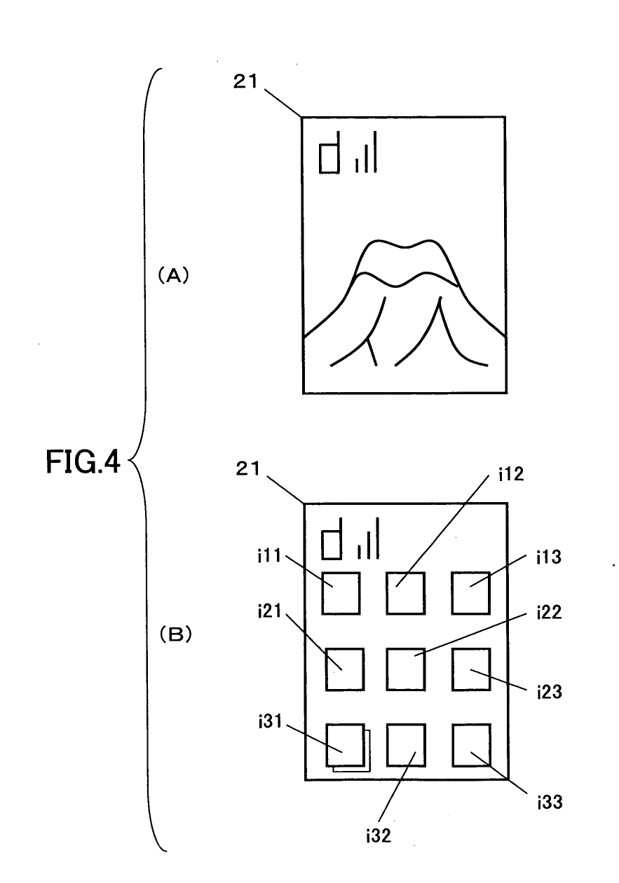

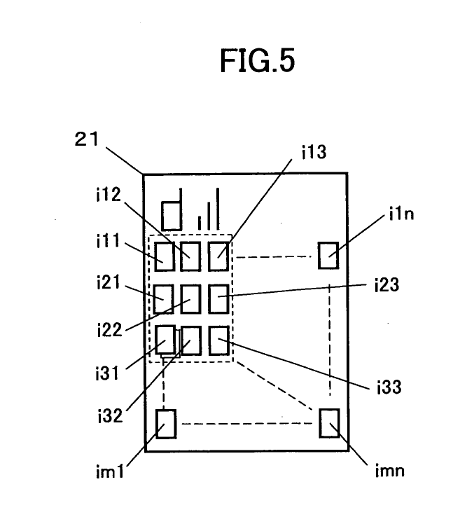

FIG. 3 is a flowchart of the item indicating process of the processing device 12. FIG. 4-(A) is a schematic view of a waiting state picture. FIG. 4-(B) is a schematic view of a first items indication picture. FIG. 5 is a schematic view of a second items indication picture.

The item indicating process is a program implemented by the process device 12 and stored in the memory device 13.

Referring to FIG. 3, the processing device 12 indicates the waiting state picture shown in FIG. 4-(A) in step S1-1. Based on the input operation by the key input device 14 in step S1-2, the first items indication picture shown in FIG. 4-(B) is indicated.

The first items indication picture is a picture where some of the items arranged in a matrix shape of n columns×m rows are indicated as enlarged. For example, as shown in FIG. 4-(B), items i11-i13, i21-i23, and i31-i33 are indicated in a matrix shape of 3 columns×3 rows. Each of the items is indicated as an icon indicating a function of the item. A selected item is indicated with a shadow. For example, the item i31 shown in FIG. 4-(B) is selected and a shadow is attached.

If the coordinates input key 31 is turned on in step S1-4, the selected item is moved in a direction corresponding to the key that is turned on of the coordinates input keys 31, namely either one of the X1, X2, Y1 or Y2 directions, in step S1-5.

For example, in a case where the item i22 is selected, if the X1 direction coordinates moving key 31a is operated, the item i21 is now selected. If the X2 direction coordinates moving key 31b is operated, the item i23 is now selected. If the Y1 direction coordinates moving key 31c is operated, the item i12 is now selected. If the Y2 direction coordinates moving key 31d is operated, the item i32 is now selected.

If the zoom switch 32 is turned on in step S1-6, as shown in FIG. 5, the second items indication picture where all of the items i11-i1n, i21-i2n, . . . , and im1-imn of n columns×m rows is indicated on the indication picture 21 of the indicating device 11 in step S1-7.

Although in this example, the second items indication picture is indicated on the entirety of the indicating picture 21 of the indicating device 11, the second items indication picture may be indicated on a part of the indicating picture 21 of the indicating device 11.

Here, a modified example of the second items indication picture is discussed.

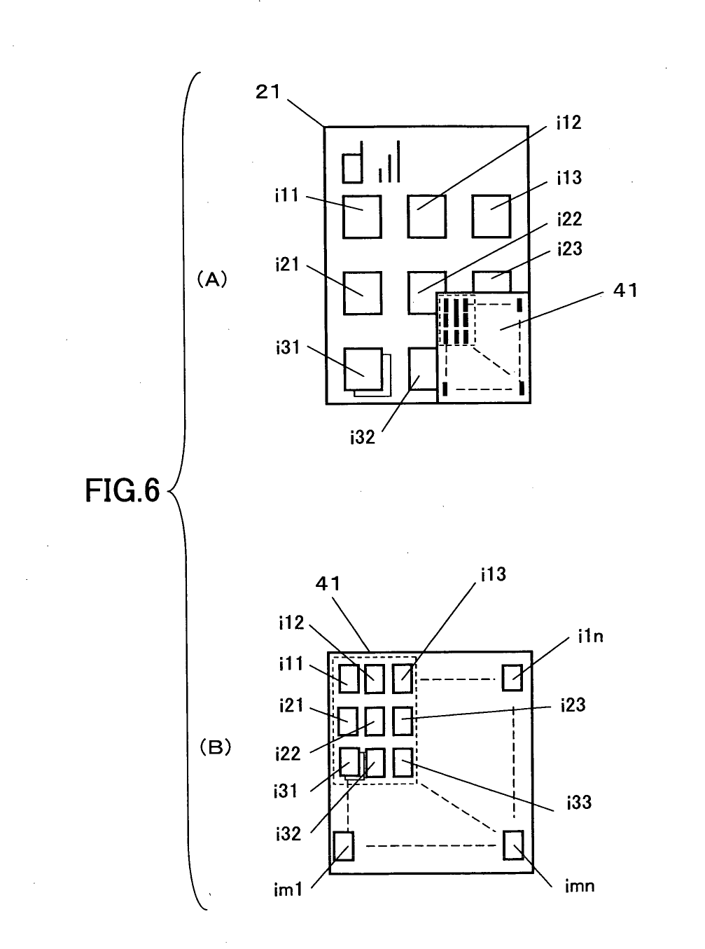

FIG. 6 is a schematic view of an indication picture of a modified example of the second items indication picture. More specifically, FIG. 6-(A) shows an indication state of the indication picture 21 of the indicating device 11 and FIG. 6-(B) shows an indication state of the second items indication picture 41.

As shown in FIG. 6-(A), the second items indication picture 41 of this modified example is indicated at a lower-right part of the first items indication picture as a part of the indication picture 21. In the second items indication picture 41, as shown in FIG. 6-(B), the selected item i31 is indicated (provided) with a shadow.

In this modified example, indications of the items are made scaled-down and therefore it is not easy to identify the items. Because of this, different colors are used for items having different functions so that the item to be selected can be easily identified.

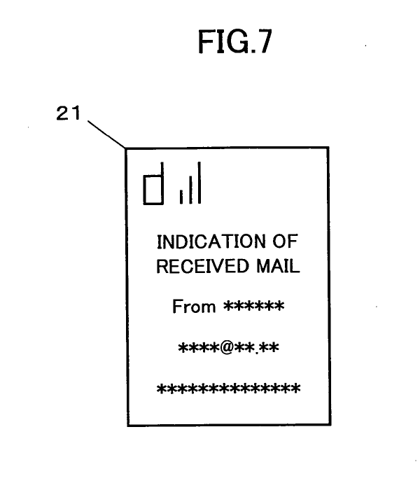

Referring back to FIG. 3, if the zoom switch 32 is turned off in step S1-8, the process goes back to step S1-3 so that the first items selection picture is indicated by the indicating device 11. In addition, it is possible to implement a function set to the selected item by operating an implementation key set at the key input device 14. For example, in a case where a received mail indication item is selected, as shown in FIG. 7, received mail is indicated.

In this example, while the zoom switch 32 is turned on, the second items indication picture where all of the items i11-i1n, i21-i2n, . . . , and im1-imn of n columns×m rows, as shown in FIG. 5, are indicated. It is possible to easily recognize where the selected item is in the entirety of items by turning on the zoom switch 32. Hence, it is possible to improve operability for selecting the items.

Furthermore, in this example, it is possible to manage all of the items as a single menu and therefore not necessary to manage the items by a hierarchical structure. Hence, it is possible to easily manage the items.

Although the second items indication picture is indicated only when the zoom switch 32 is turned on in this example, the present invention is not limited to this. For example, the first and second items indication pictures may be indicated alternately by turning on the zoom switch 32. Alternatively, the second items indication picture may be indicated for a designated time after the zoom switch 32 is turned on.

### FIRST MODIFIED EXAMPLE OF THE ITEM INDICATING PROCESS

Next, the first modified example of the item indicating process by the processing device 12 is discussed.

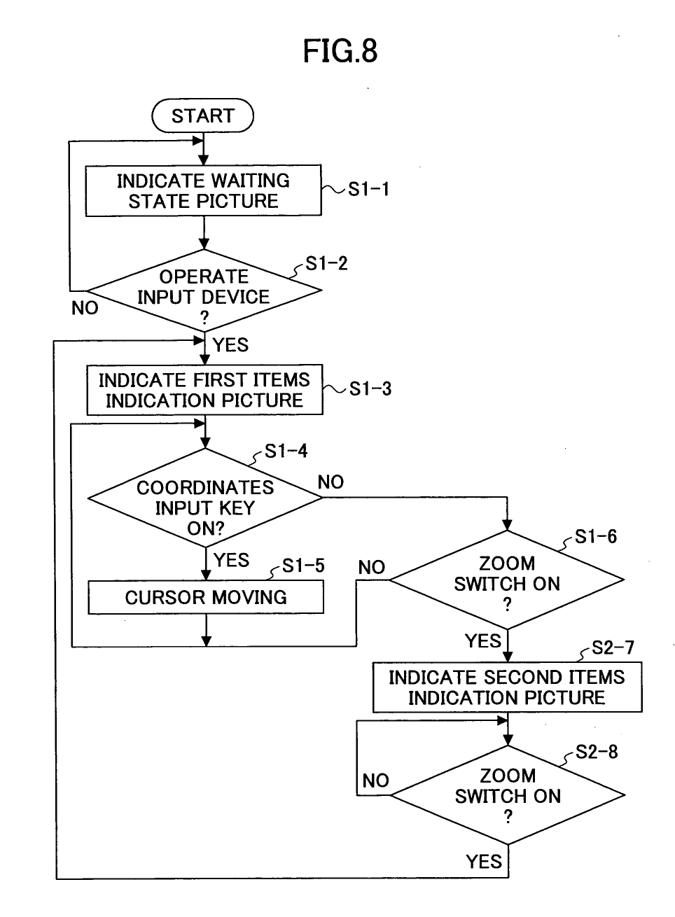

FIG. 8 is a flowchart of the first modified example of the item indicating process. In FIG. 8, steps that are the same as the steps shown in FIG. 3 are given the same reference numerals, and explanation thereof is omitted.

In this modified example, after the zoom switch 32 is turned on in step S1-6, the second items indication picture as shown in FIG. 5 is indicated in step S2-7. If the zoom switch 32 is turned on again in step S2-8, the process goes back to step S1-3 so that the first items indication picture shown in FIG. 4-(B) is indicated.

According to this example, the first and second items indication pictures can be indicated alternately for every operation of the zoom switch 32. Hence, it is possible for the user to selectively indicate the first or second items indication picture.

### SECOND MODIFIED EXAMPLE OF THE ITEM INDICATING PROCESS

Next, the second modified example of the item indicating process by the processing device 12 is discussed.

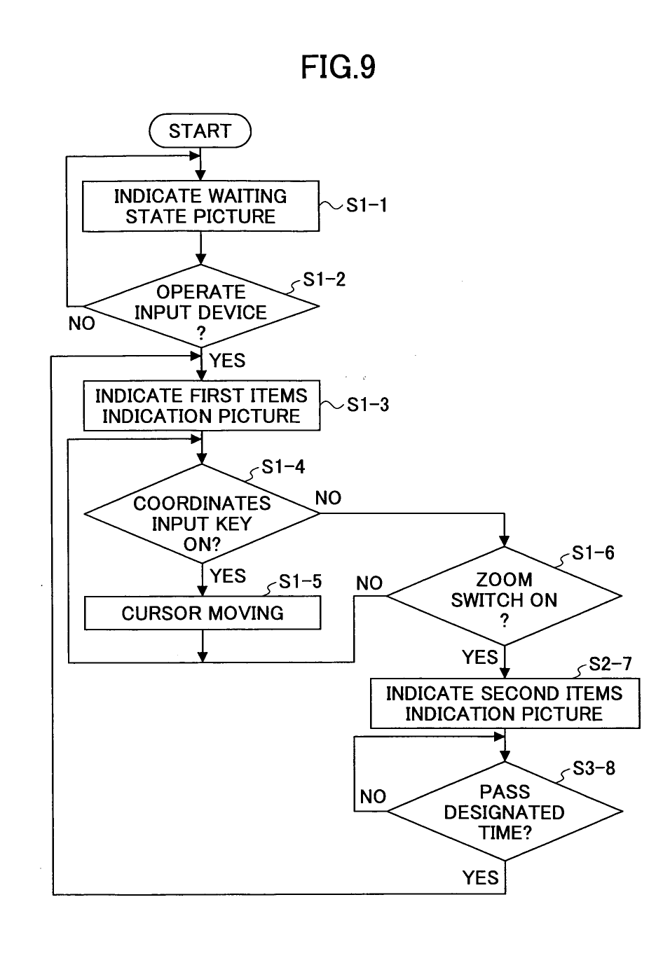

FIG. 9 is a flowchart of the second modified example of the item indicating process. In FIG. 9, steps that are the same as the steps shown in FIG. 3 are given the same reference numerals, and explanation thereof is omitted.

In this example, after the second items indication picture shown in FIG. 5 is indicated on the indicating device 11 in step S2-7 and then a designated time passes in step S3-8, the process goes back to the step S1-3 so that the first items indication picture shown in FIG. 4-(B) is indicated on the indication picture 21 of the indicating device 11.

According to this example, it is possible to indicate the second items indication pictures for a designated time by operating the zoom switch 32. Hence, it is possible for the user to selectively indicate the first or second items indication picture, so that the operability of the device can be improved.

### THIRD MODIFIED EXAMPLE OF THE ITEM INDICATING PROCESS

Next, the third modified example of the item indicating process by the processing device 12 is discussed.

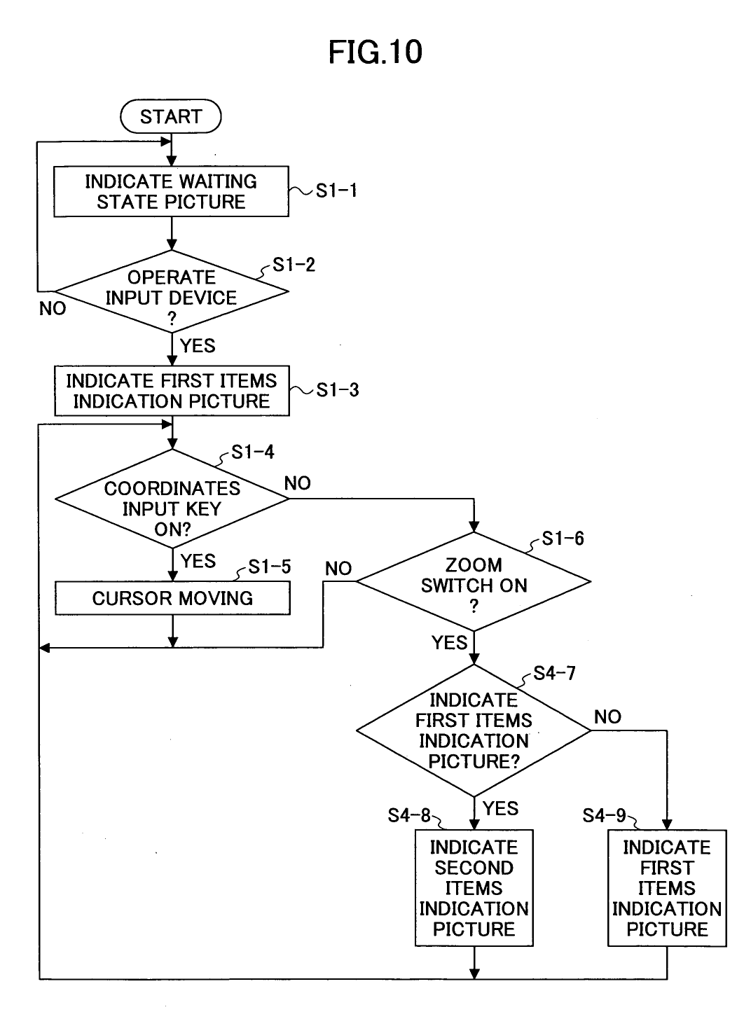

FIG. 10 is a flowchart of the third modified example of the item indicating process. In FIG. 10, steps that are the same as the steps shown in FIG. 3 are given the same reference numerals, and explanation thereof is omitted.

In this modified example, after the zoom switch 32 is turned on in step S1-6, whether a present indicated picture is the first items indication picture is determined in step S4-7. In a case where it is determined in step S4-7 that the first items indication picture shown in FIG. 4-(B) is indicated on the indicating device 11, the second items indicating picture shown in FIG. 5 is indicated in step S4-8 and the process goes back to the step S1-4 so that a process for selecting the item can be continued.

In a case where it is determined in step

S4-7 that the first items indication picture shown in FIG. 4-(B) is not indicated on the indicating device 11, that is, the second items indicating picture shown in FIG. 5 is indicated on the indicating device 11, the first items indication picture shown in FIG. 4-(B) is indicated (selected) on the indication picture 21 of the indicating device 11 in step S4-9.

According to this example, the first and second items indication pictures can be indicated alternately for every operation of the zoom switch 32. Hence, it is possible for the user to selectively indicate the first or second items indication picture.

### FOURTH MODIFIED EXAMPLE OF THE ITEM INDICATING PROCESS

In this modified example, the zoom switch 32 has a two-step depression switch structure.

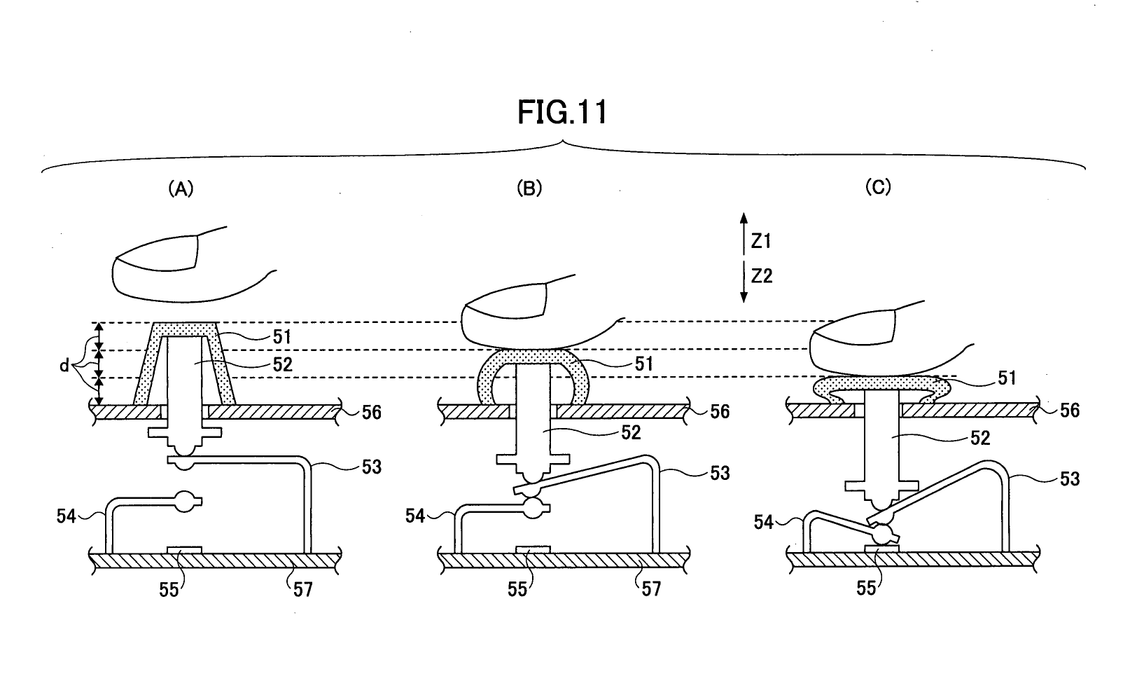

FIG. 11 is a schematic view for explaining a two-step depression switch. More specifically,

FIG. 11-(A) is a schematic view when the switch is not operated. FIG. 11-(B) is a schematic view when the switch is depressed at one step. FIG. 11-(C) is a schematic view when the switch is depressed at two steps.

The two-step depression switch is formed by a key top 51, a lever 52, a first contact 53, a second contact 54, and a third contact 55.

The key top 51 is made of, for example, rubber. The key top 51 can be elastically deformed on the case 56 when being depressed in the Z2 direction. The lever 52 is made of an insulation material such as resin. One end of the lever 52 pierces the case in the Z1 and Z2 directions and is fixed to a lower surface side of the key top 51. The other end at the Y2 side of the lever 52 comes in contact with a first contact 53. When the key top 51 is depressed in the Z2 direction for a distance “d”, the lever 52 moves in the Z2 direction for the a distance “d” so that the first contact 53 comes in contact with the second contact 54. As a result of this, the first contact 53 and the second contact 54 are shorted so that a first switching operation is detected.

When the key top 51 is further depressed in the Z2 direction for a distance “d”, the lever 52 further moves in the Z2 direction for the distance “d” so that the second contact 54 comes in contact with the third contact 55. As a result of this, the first contact 53, the second contact 54, and the third contact 55 are shorted so that a second switching operation is detected.

Next, the item indicating process using the above-mentioned two-step depression switch is discussed.

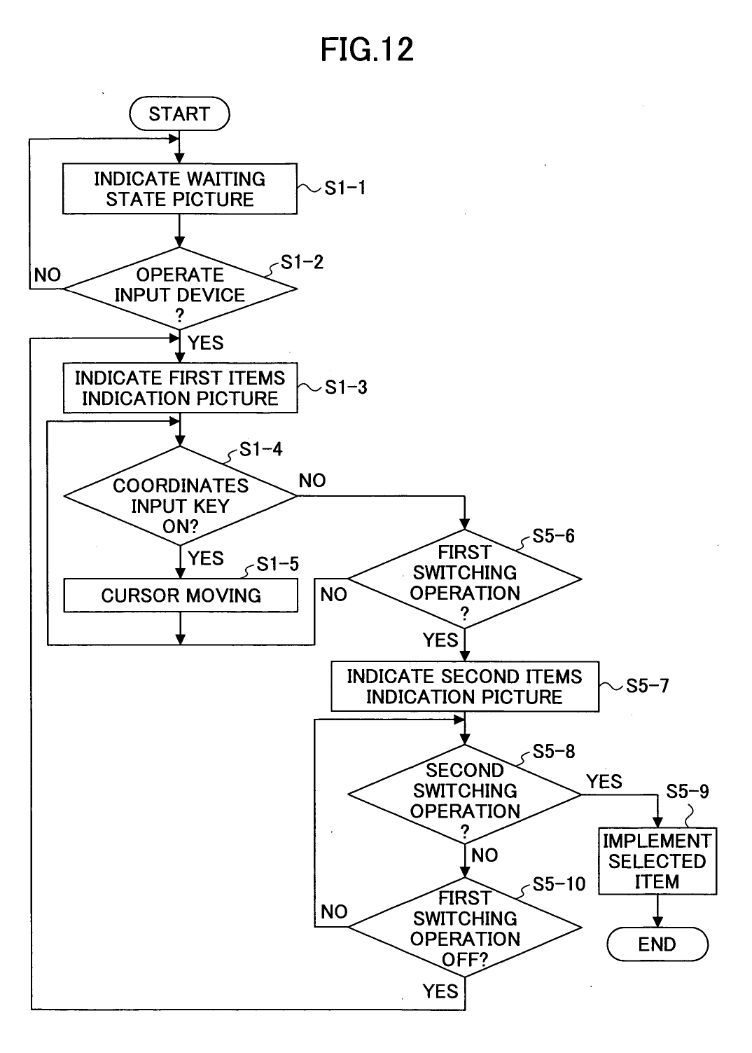

FIG. 12 is a flowchart of the fourth modified example of the item indicating process. In FIG. 12, steps that are the same as the steps shown in FIG. 3 are given the same reference numerals, and explanation thereof is omitted.

In this modified example, after the first switching operation of the two-step switch is done in step S5-6, the second items indication picture as shown in FIG. 5 or FIG. 6-(A) is indicated in step S5-7. If the second switching operation of the two-step switch is done in step S5-8, the selected item is implemented in step S5-9. For example, if the second switching operation of the two-step switch is done in a state where an item for receiving mail is selected, as shown in FIG. 7, an item implementation picture for receiving mail is indicated on the indication picture 21 of the indicating device 11.

If the first switching operation is turned off in step S5-10, the process goes back to step S1-3 so that the first items indication picture as shown in FIG. 4-(B) is indicated on the indication picture 21 of the indicating device 11.

According to this modified example, it is possible to implement selecting items by the second switching operation of the two-step switch, and thereby it is possible to further improve operability of the device.

### FIFTH MODIFIED EXAMPLE OF THE ITEM INDICATING PROCESS

In this modified example, the zoom switch 32 has a two-step depression switch structure.

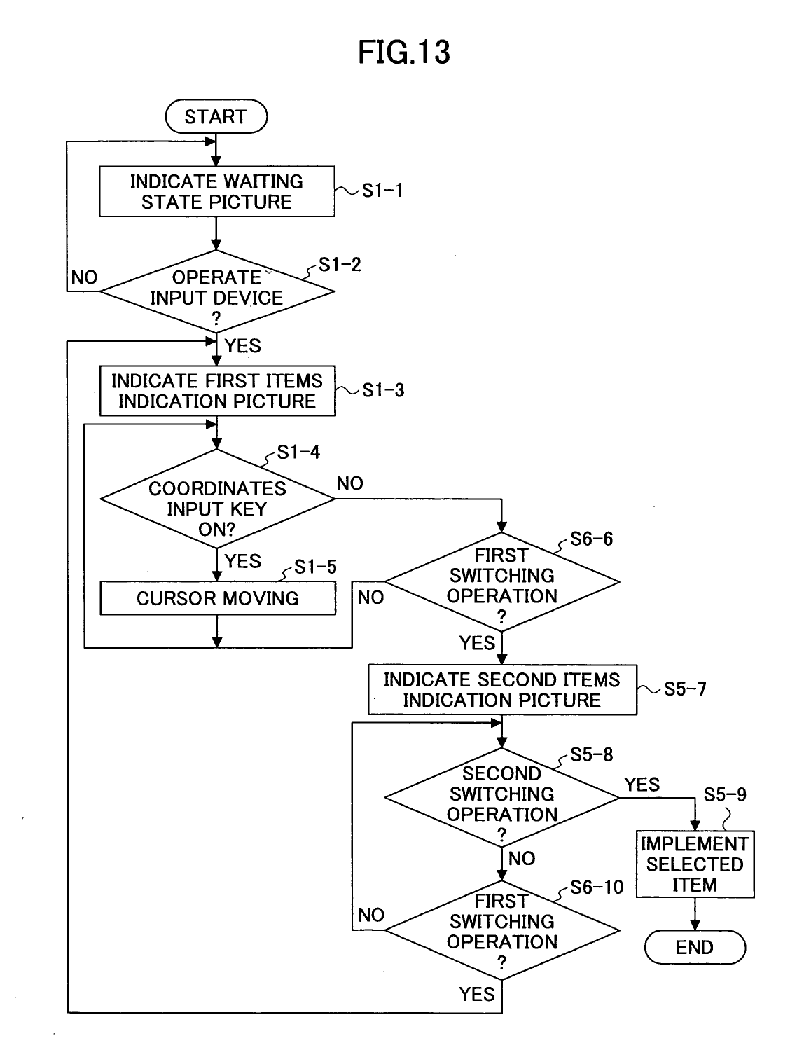

FIG. 13 is a flowchart of the fifth modified example of the item indicating process. In FIG. 13, steps that are the same as the steps shown in FIG. 12 are given the same reference numerals, and explanation thereof is omitted.

In this modified example, if the first switching operation of the two-step switch is done in step S6-6, the second items indication picture as shown in FIG. 5 or FIG. 6-(A) is indicated in step S5-7.

If the first switching operation of the two-step switch is done again in step S6-10, the process goes back to step S1-3 so that the first items indication picture as shown in FIG. 4-(B) is indicated on the indication picture 21 of the indicating device 11.

According to this modified example, it is not necessary to continue depressing the zoom switch 32 at the time when the second items indication picture is indicated, and thereby it is possible to improve operability of the device.

### SIXTH MODIFIED EXAMPLE OF THE ITEM INDICATING PROCESS

In this modified example, the zoom switch 32 has a two-step depression switch structure.

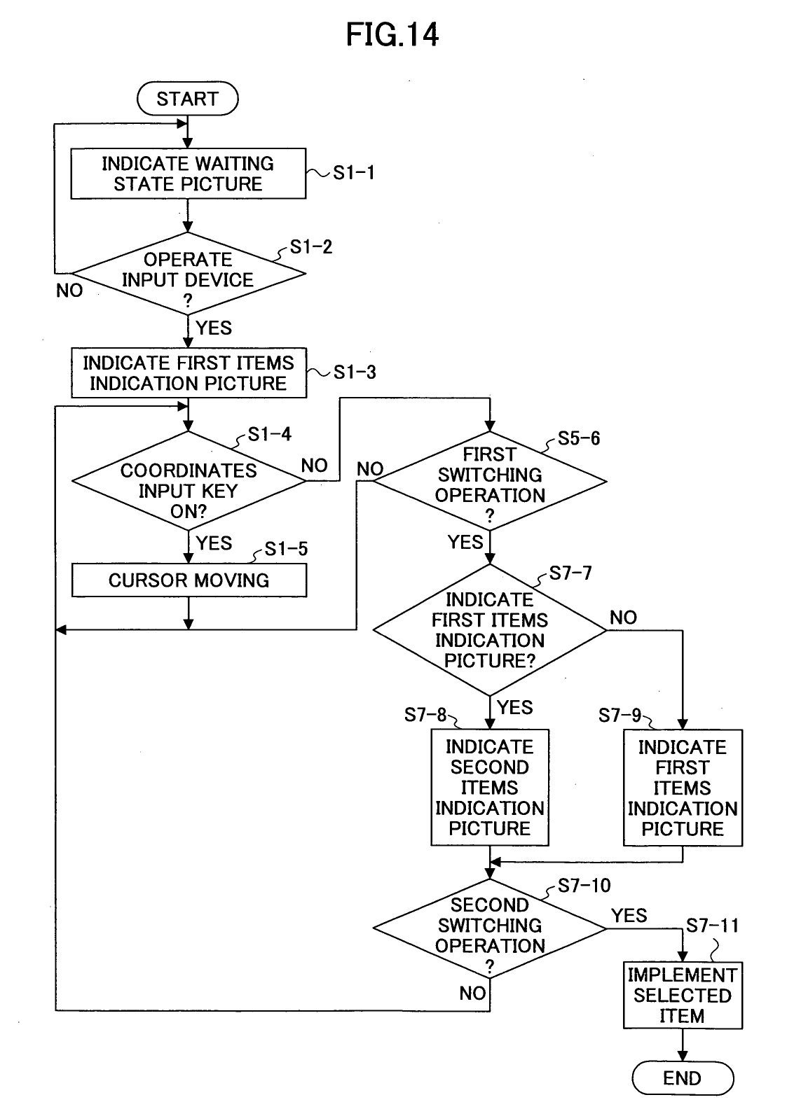

FIG. 14 is a flowchart of the sixth modified example of the item indicating process. In FIG. 14, steps that are the same as the steps shown in FIG. 12 are given the same reference numerals, and explanation thereof is omitted.

In this modified example, after the first switching operation of the two-step switch is done in step S5-6, whether a present indicated picture is the first items indication picture is determined in step S7-7. In a case where it is determined in step S7-7 that the first items indication picture is indicated on the indicating device 11, the second items indicating picture shown in FIG. 5 or FIG. 6-(A) is indicated in the step S7-8. In a case where the present indicated picture is not the first items indication picture but is the second items indication picture is determined in step S7-7, the first items indicating picture shown in FIG. 4-(B) is indicated in step S7-9.

Next, whether the second switching operation of the two-step switch is done is determined in step S7-10. In a case where the second switching operation of the two-step switch is done in step S7-10, a selected item is implemented in step S7-11. In a case where the second switching operation of the two-step switch is not done in step S7-10, the process goes back to step S1-4.

According to this example, the first and second items indication pictures can be indicated alternately for every operation of the first switching operation. Hence, it is possible to improve the operability without continuing depressing the switch 32.

### SEVENTH MODIFIED EXAMPLE OF THE ITEM INDICATING PROCESS

In this modified example, the zoom switch 32 has a two-step depression switch structure.

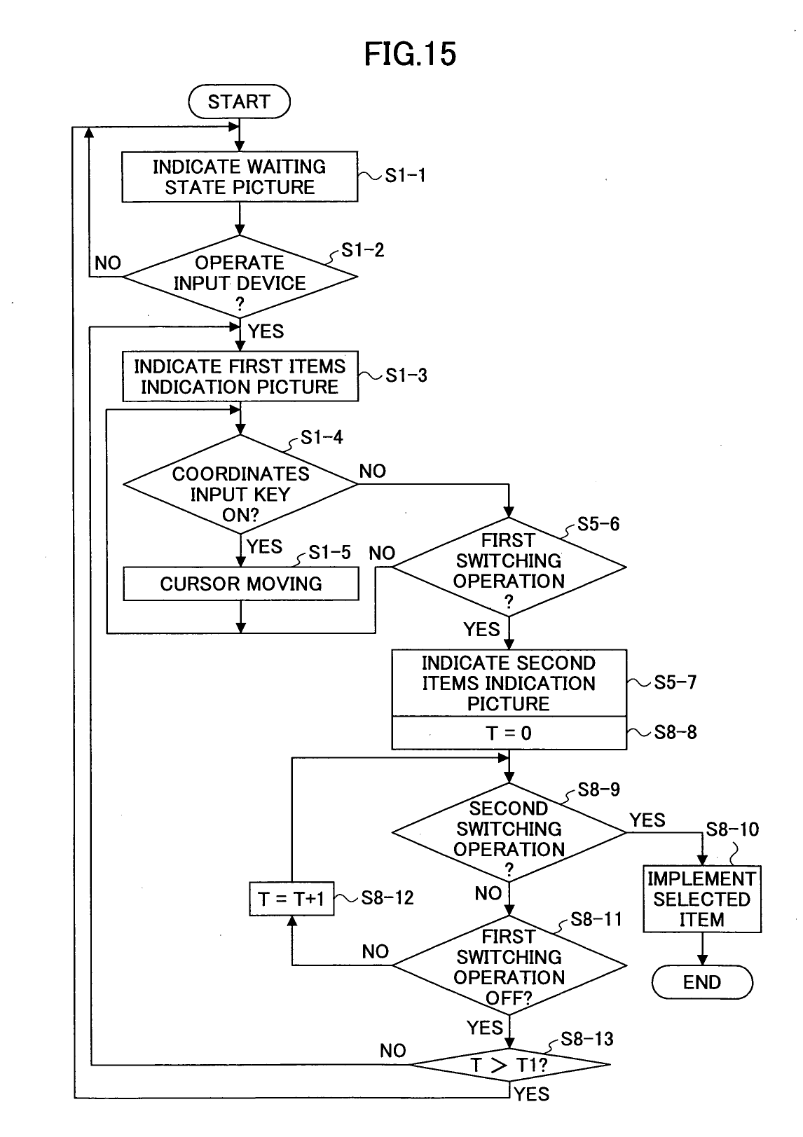

FIG. 15 is a flowchart of the seventh modified example of the item indicating process. In FIG. 15, steps that are the same as the steps shown in FIG. 12 are given the same reference numerals, and explanation thereof is omitted.

In this modified example, after the first switching operation of the two-step switch is done in step S5-6, the second items indicating picture shown in FIG. 5 or FIG. 6-(A) is indicated in the step S5-7 and a time T is reset to “0” in step S8-8. In a case where the second switching operation of the two-step switch is done in step S8-9, a selected item is implemented in step S8-10.

In steps S8-11 and S8-13, time for continuing operating the first switching operation is measured. After the first switching operation is turned off in step S8-11, whether the time T is greater than the designated time T1 is determined in step 8-13. If the time T is greater than the designated time T1, the process goes back to step S1-1 so that the picture goes back to the waiting picture shown in FIG. 4-(A). If the time T is not greater than the designated time T1, the process goes back to step S1-3 so that the picture goes back to the first items indication picture shown in FIG. 4-(B).

According to this modified example, corresponding to the operation time of the first switching operation, the waiting picture or the first items indication picture can be selectively indicated.

### EIGHTH MODIFIED EXAMPLE OF THE ITEM INDICATING PROCESS

In this modified example, the zoom switch 32 has a two-step depression switch structure.

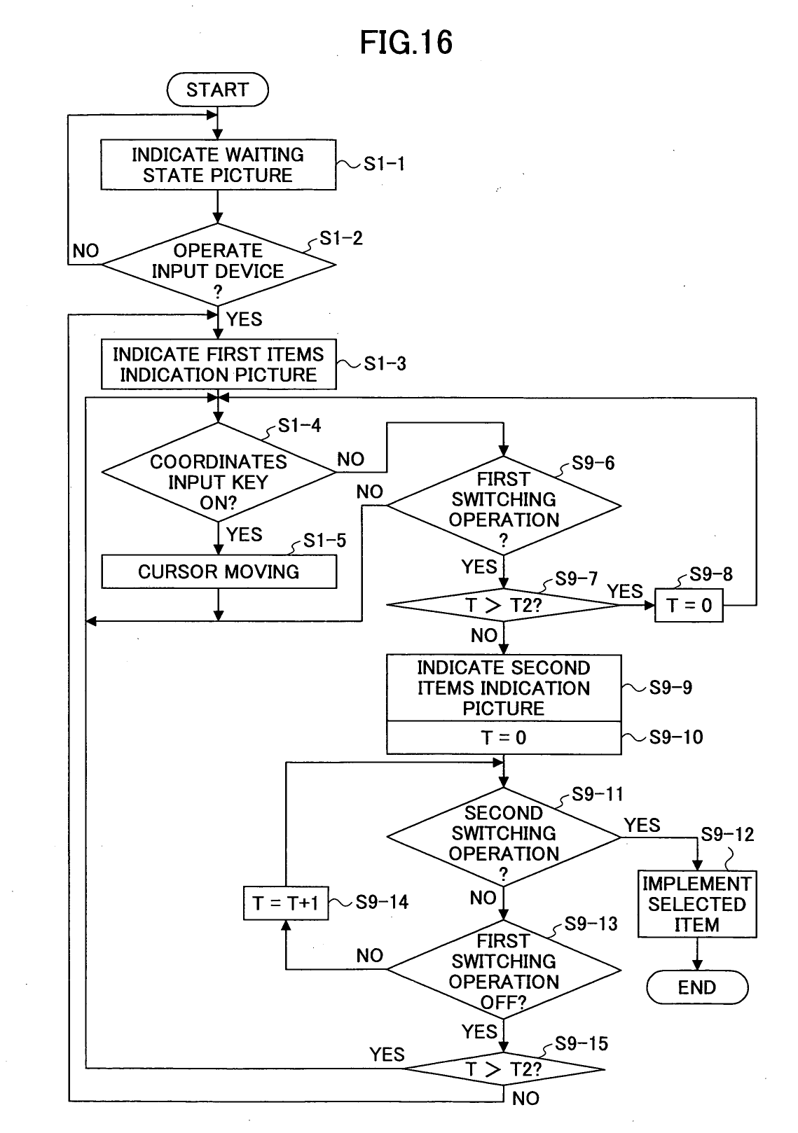

FIG. 16 is a flowchart of the eighth modified example of the item indicating process. In FIG. 16, steps that are the same as the steps shown in FIG. 12 are given the same reference numerals, and explanation thereof is omitted.

In this modified example, if the first switching operation of the two-step depression switch is continuously turned on for a designated time T2 in steps S9-6 through S9-8, the process goes back to step S1-4 so that the picture remains the first items indication picture shown in FIG. 4-(B). In a case where the first switching operation is done within the designated time T2, the second items indicating picture shown in FIG. 5 or FIG. 6-(A) is indicated in the step S9-9 and a time T is reset to “0” in step S9-10. In a case where the second switching operation of the two-step switch is done in step S9-11, a selected item is implemented in step S9-12.

In steps S9-11, S9-13 and S9-15, time for continuing operating the first switching operation is measured. After the first switching operation is turned off in step S9-13, whether the time T is longer than the designated time T2 is determined in step 9-15. If the time T is longer than the designated time T2, the process goes back to the step S1-4 so that the second items indication picture shown in FIG. 6-(A) continued to be indicated. If the time T is shorter than the designated time T2, the process goes back to step S1-3 so that the picture goes back to the first items indication picture shown in FIG. 4-(B).

According to this modified example, corresponding to the operation time of the first switching operation, the first or second items indication picture can be selectively indicated.

### NINTH MODIFIED EXAMPLE OF THE ITEM INDICATING PROCESS

In this modified example, the zoom switch 32 has a two-step depression switch structure.

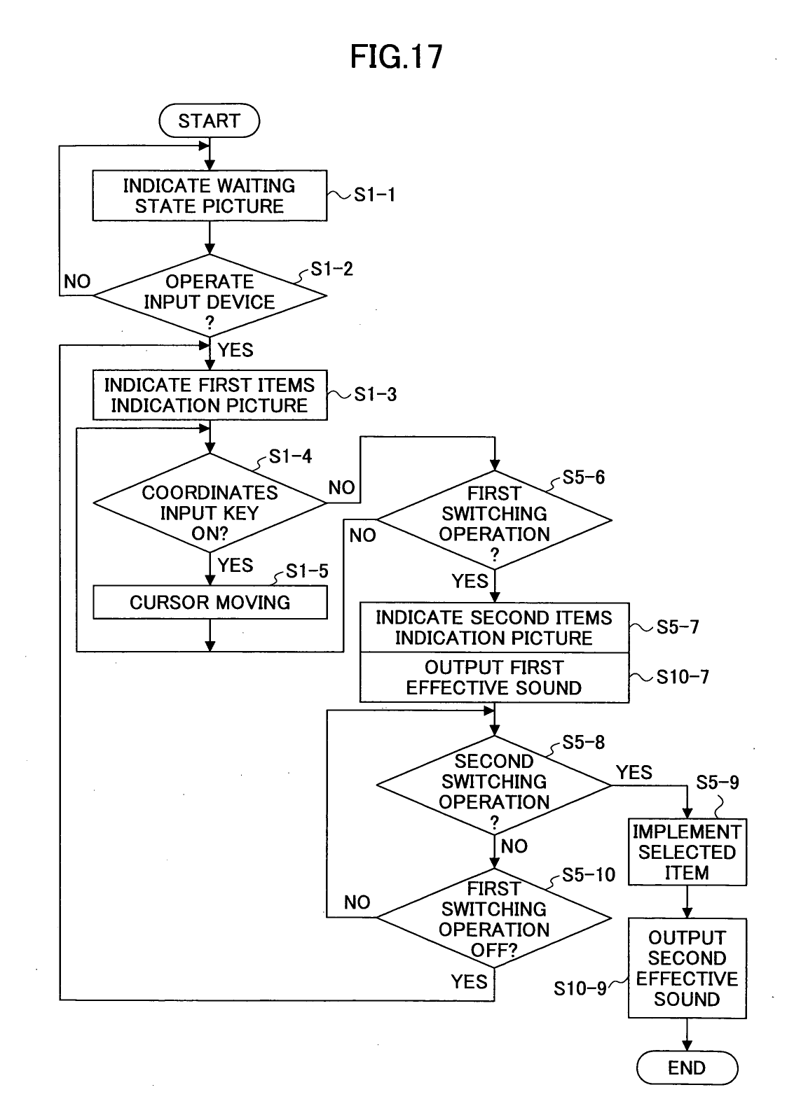

FIG. 17 is a flowchart of the ninth modified example of the item indicating process. In FIG. 17, steps that are the same as the steps shown in FIG. 12 are given the same reference numerals, and explanation thereof is omitted.

In this modified example, the second items indication picture shown in FIG. 5 or FIG. 6-(A) is indicated in step S5-7. In addition, a first effective sound is output from the voice output device 16 in step S10-7. Furthermore, when the selected item is implemented in step S5-9, the second effective sound is output from the voice output device 16.

According to this modified example, the user can realize by the first effective sound that the second items indication picture is indicated. The user can also realize by the second effective sound that the selected item is implemented.

### TENTH MODIFIED EXAMPLE OF THE ITEM INDICATING PROCESS

In this modified example, the zoom switch 32 has a three-step depression switch structure.

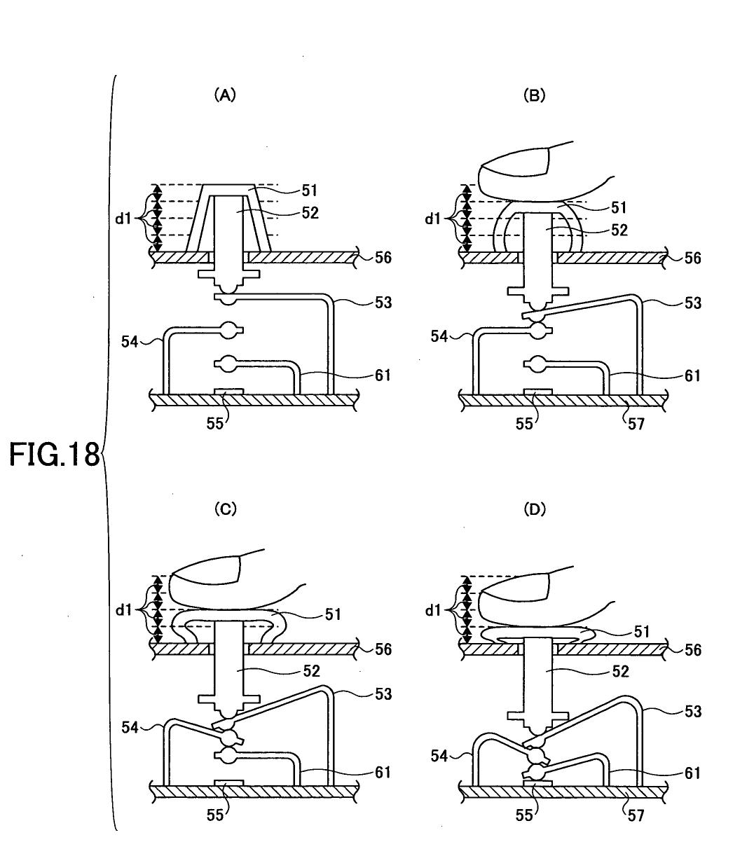

FIG. 18 is a schematic view for explaining a three-step depression switch. More specifically, FIG. 18-(A) is a schematic view when the switch is not operated. FIG. 18-(B) is a schematic view when the switch is depressed at one step. FIG. 18-(C) is a schematic view when the switch is depressed at two steps. FIG. 18-(D) is a schematic view when the switch is depressed at three steps. In FIG. 18, steps that are the same as the steps shown in FIG. 11 are given the same reference numerals, and explanation thereof is omitted.

The three-step depression switch is formed by the key top 51, the lever 52, the first contact 53, the second contact 54, the third contact 55 and a fourth contact 61.

When the key top 51 is depressed in the Z2 direction for a distance “d1”, the lever 52 moves in the Z2 direction for the distance “d1” so that the first contact 53 comes in contact with the second contact 54. As a result of this, the first contact 53 and the second contact 54 are shorted so that a first switching operation is detected.

When the key top 51 is further depressed in the Z2 direction for a distance “d4”, the lever 52 further moves in the Z2 direction for the distance “d1” so that the second contact 54 comes in contact with the third contact 55. As a result of this, the first contact 53, the second contact 54, and the third contact 55 are shorted so that a second switching operation is detected.

When the key top 51 is further depressed in the Z2 direction at a distance “d1”, the lever 52 further moves in the Z2 direction for a distance “d1” so that the first contact 53, the second contact 54 and the fourth contact 61 come in contact with the third contact 55. As a result of this, a third switching operation is detected.

Next, the item indicating process using the above-mentioned three-step depression switch is discussed.

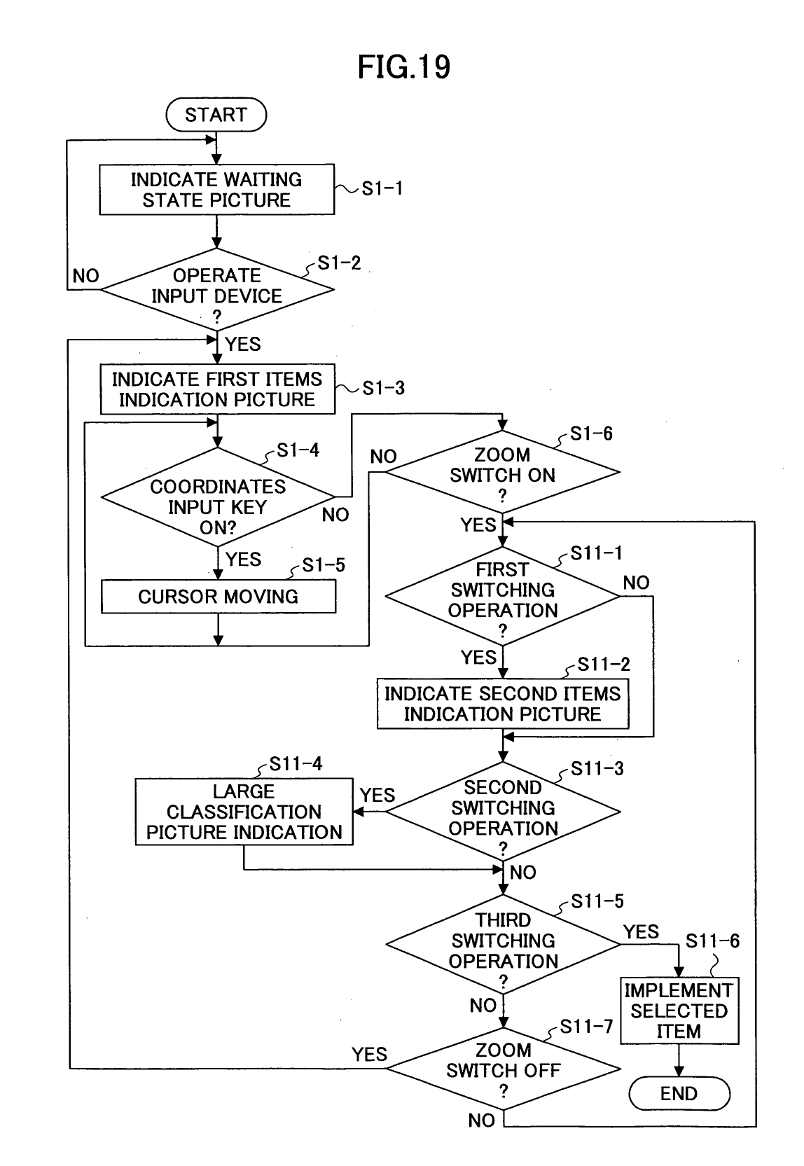

FIG. 19 is a flowchart of the tenth modified example of the item indicating process. In FIG. 19, steps that are the same as the steps shown in FIG. 3 are given the same reference numerals, and explanation thereof will be omitted.

In the modified example, the zoom switch 32 is operated in step S1-6 and the first switching operation of the three-step switch is done in step S11-1, and then the second items indication picture as shown in FIG. 5 or FIG. 6-(A) is indicated in step S11-2. If the second switching operation of the three-step switch is done in step S11-3, a large classification picture is indicated in step S11-4.

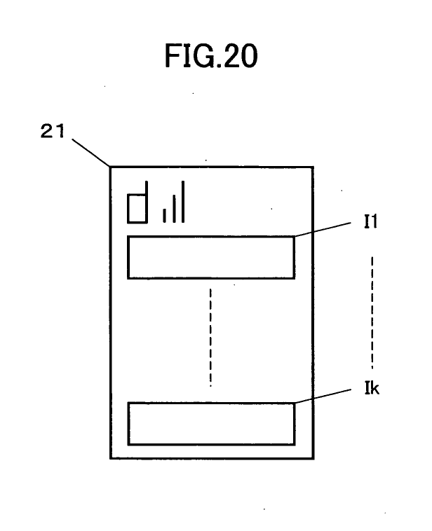

FIG. 20 is a schematic view of the indication picture for explaining a large classification picture indication.

In the large classification picture indication, large classification items I1 through Ik where items i11 through i1n, i21 through 2n, . . . , im1 through imn are classified as large are indicated on the indication picture 21 of the indicating device 11. Items such as “mail”, “setting”, “phone book”, or “calculator” are provided as the large classification items I1 through Ik.

After the third switching operation of the three-step switch is implemented in step S11-5, the item selected at this time is implemented in step S11-6.

After the operation of the zoom switch 32 is turned off in step S11-7, the process goes back to the step S1-3 so that the first items indication picture shown in FIG. 4-(B) is indicated on indication picture 21 of the indicating device 11.

According to this modified example, the first items indication picture is indicated by the first switching operation of the three-step switch. The large classification picture is indicated by the second switching operation. The selected item is implemented by the third switching operation. Thus, it is possible to further improve the operability of the device.

The present invention is not limited to these embodiments, but variations and modifications may be made without departing from the scope of the present invention.

In the above mentioned embodiments, the one-step, two-step, or three-step depressing structure switch for switching the first and second items indication picture is used as the zoom switch 32. The zoom switch 32 may be used for switching the first through “n”th items indication pictures. The first through “n”th items indication pictures may be switched by using the “n”-step depressing switch. In this case, the first through “n”th items indication pictures may have not only the various number of indicated items but also various classification. Furthermore, although a case where the present invention is used for a portable phone is explained in the above-mentioned embodiments, the present invention is not limited to this. For example, the present invention can be used for indications of items or menus of other types of the information processing devices.

This patent application is based on

Japanese Priority Patent Application No. 2004-348419 filed on Dec. 1, 2004 and the entire contents of which are hereby incorporated by reference.

What is claimed is:

1. An information processing device, comprising:
an indicating part capable for indicating plural items on an indication picture;
an indication switch configured to switch the number of the items indicated on the indication picture of the indicating part; and
an items indication control part configured to switch the number of items indicated on the indication picture corresponding to the operation of the indication switch.

2. The information processing device as claimed in claim 1,
wherein the items indication control part switches the number of the items indicated on the indication picture while the indication switch is operated.

3. The information processing device as claimed in claim 1,
wherein the items indication control part switches the number of the items indicated on the indication picture for every operation of the indication switch.

4. The information processing device as claimed in claim 1,
wherein the items indication control part switches the number of the items indicated on the indication picture for a designated time after the indication switch is operated.

5. The information processing device as claimed in claim 1,
wherein the items indication control part switches a first indication wherein a part of the items are indicated on the indicating part and a second indication wherein all of the items are indicated on the indicating part, corresponding to the operation of the indication switch.

6. The information processing device as claimed in claim 1,
wherein the items indication control part indicates all of the items on an intruding picture, corresponding to the operation of the indication switch.

7. The information processing device as claimed in claim 1, further comprising:
a selection switch configured to select the item;
wherein a process corresponding to an item selected by the selection switch is implemented.

8. A method for indicating items, comprising:
a step of switching the number of items indicated on an indication picture of an indicating part, corresponding to the operation of an indication switch.

9. The method for indicating the items as claimed in claim 8,
wherein the number of the items indicated on the indication picture is switched while the indication switch is operated.

10. The method for indicating the items as claimed in claim 8,
wherein the number of the items indicated on the indication picture is switched for every operation of the indication switch.

11. The method for indicating the items as claimed in claim 8,
wherein the number of the items indicated on the indication picture is switched for a designated time after the indication switch is operated.

12. The method for indicating the items as claimed in claim 8,
wherein a first indication wherein a part of the items are indicated on the indicating part and a second indication wherein all of the items are indicated on the indicating part are switched, corresponding to the operation of the indication switch.

13. The method for indicating the items as claimed in claim 8,
wherein all of the items are indicated on an intruding picture, corresponding to the operation of the indication switch.

14. The method for indicating the items as claimed in claim 8,
wherein a process corresponding to an item selected by a selection switch is implemented.

15. A computer program product for indicating items, the product having a computer readable program, the program comprising:
a step of switching the number of items indicated on an indication picture of an indicating part, corresponding to the operation of an indication switch.

16. The computer program product for indicating the items as claimed in claim 15,
wherein the number of the items indicated on the indication picture is switched while the indication switch is operated.

17. The computer program product for indicating the items as claimed in claim 15,
wherein the number of the items indicated on the indication picture is switched for every operation of the indication switch.

18. The computer program product for indicating the items as claimed in claim 15,
wherein the number of the items indicated on the indication picture is switched for a designated time after the indication switch is operated.

19. The computer program product for indicating the items as claimed in claim 15,
wherein a first indication wherein a part of the items are indicated on the indicating part and a second indication wherein all of the items are indicated on the indicating part are switched, corresponding to the operation of the indication switch.

20. The computer program product for indicating the items as claimed in claim 15,
wherein all of the items are indicated on an intruding picture, corresponding to the operation of the indication switch.

21. The computer program product for indicating the items as claimed in claim 15,
wherein a process corresponding to an item selected by a selection switch is implemented.
